(19) United States
(12) Patent Application Publication
(10) Pub. No.: US 2010/0208896 A1
(43) Pub. Date: Aug. 19, 2010

(54) COMMUNICATION APPARATUS AND CONTROL METHOD THEREOF

(75) Inventor: Fumihide Goto, Naka-gun (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/681,015

(22) PCT Filed: Dec. 2, 2008
(86) PCT No.: PCT/JP2008/072225

§ 371 Date: Mar. 31, 2010

(30) Foreign Application Priority Data
Dec. 5, 2007 (JP) 2007-314794

(51) Int. Cl. H04L 9/08

(52) U.S. Cl. 380/279

(57) ABSTRACT

A first communication apparatus that functions as a providing apparatus that provides an encryption key or as a receiving apparatus that receives an encryption key provided by a providing apparatus, and that performs a key sharing process for sharing an encryption key with another apparatus, the first communication apparatus includes: acquisition means for acquiring identification information of a second communication apparatus that functioned as the providing apparatus in the key sharing process performed among a plurality of apparatuses present on a network which the first communication apparatus is to join; and determination means for determining whether the first communication apparatus is to function as the providing apparatus or as the receiving apparatus based on the result of a comparison between the identification information of the second communication apparatus acquired by the acquisition means and identification information of the first communication apparatus.

### TECHNICAL FIELD

The present invention relates to a communication apparatus and a control method thereof.

### BACKGROUND ART

Communication data is conventionally encrypted in order to prevent the data from being intercepted, tampered with, and so on. Ensuring a secure communication path is particularly important in wireless communication, where data can easily be intercepted.

For example, in the infrastructure mode for wireless LAN, the communication terminal and access point are provided with a standard specification known as WEP (Wired Equivalent Privacy). With WEP, an encryption key is set in the communication terminal and access point in advance, and security is ensured by using that encryption key each time communication is undertaken. However, in such a scheme, the encryption key is constantly fixed, and the strength of the encryption algorithms employed in WEP is low. For these reasons, it has been pointed out that there are many situations where WEP cannot ensure security.

To solve this problem, a standard specification known as WPA (Wi-Fi Protected Access) has been developed. WPA increases security not only by improving the strength of the encryption algorithms, but also by generating a new encryption key for each session in which a communication terminal joins a network.

In infrastructure mode, data is sent to other communication terminals via an access point, and thus the only direct communication that is performed is performed with the access point. It is therefore only necessary to ensure the security of communication with the access point. However, in ad-hoc mode, there is no access point, and thus communication is carried out directly with the partner with which one wishes to communicate. In other words, in order for terminals to carry out encrypted communication with other terminals, it is necessary for the each terminal to either hold encryption keys for each of the other terminals or to utilize an encryption key that is common across the entire network.

In the case where each terminal holds an encryption key for each of the other terminals, it becomes more complicated and difficult to manage the encryption keys as the number of terminals increases.

However, utilizing an encryption key that is common across the entire network reduces the load of each terminal with respect to key management.

For example, Japanese Patent Laid-Open No. 2006-332895 discusses a method for using encryption keys in ad-hoc mode.

However, when using a common encryption key, there is a problem that it is difficult to distribute the same encryption key to new terminals that have newly joined the network.

The WPA scheme for wireless LANs uses a “group key” as an encryption key shared by multiple terminals. By implementing a four-way handshake and a group key handshake, the group key is sent from the terminal that initiated the four-way handshake to the partner terminal. However, the terminal that initiates the four-way handshake is not set when in ad-hoc mode.

Furthermore, in ad-hoc mode, there is no scheme for intensively managing the terminals that are present on a network. The terminals already joining the network thus do not know which terminals do not hold the group key. For this reason, it is difficult for the terminals already joining the network to discover which terminals do not hold the group key and initiate a four-way handshake.

Finally, when a terminal that has newly joined the network initiates a four-way handshake, the new terminal ends up distributing the group key, and thus the group key that has been used on the network thus far cannot be distributed to the new terminal.

### DISCLOSURE OF INVENTION

It is an object of the present invention to enable an encryption key to be shared with communication apparatuses that have newly joined a network even in an environment such as an ad-hoc mode.

According to one aspect of the present invention, a first communication apparatus that functions as a providing apparatus that provides an encryption key or as a receiving apparatus that receives an encryption key provided by a providing apparatus, and that performs a key sharing process for sharing an encryption key with another apparatus, the first communication apparatus includes:

acquisition means for acquiring identification information of a second communication apparatus that functioned as the providing apparatus in the key sharing process performed among a plurality of apparatuses present on a network which the first communication apparatus is to join; and

determination means for determining whether the first communication apparatus is to function as the providing apparatus or as the receiving apparatus based on the result of a comparison between the identification information of the second communication apparatus acquired by the acquisition means and identification information of the first communication apparatus.

According to another aspect of the present invention, a control method for a first communication apparatus that functions as a providing apparatus that provides an encryption key or as a receiving apparatus that receives an encryption key provided by a providing apparatus, and that performs a key sharing process for sharing an encryption key with another apparatus, the method includes the steps of:

acquiring identification information of a second communication apparatus that functioned as the providing apparatus in the key sharing process performed among a plurality of apparatuses present on a network which the first communication apparatus is to join; and

determining whether the first communication apparatus is to function as the providing apparatus or as the receiving apparatus based on the result of a comparison between the identification information of the second communication apparatus acquired in the step of acquiring and identification information of the first communication apparatus.

According to the present invention, it is possible for an encryption key to be shared with communication apparatuses that have newly joined a network even in an environment such as an ad-hoc mode.

Further features of the present invention will become apparent from the following description of an exemplary embodiment (with reference to the attached drawings).

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram illustrating a terminal.

FIG. 2 is a diagram illustrating a configuration in which three terminals form an ad-hoc network.

FIG. 3 is a software function block diagram illustrating the inside of a terminal.

FIG. 4 is a sequence diagram (1) illustrating operations performed by terminals A, B, and C.

FIG. 5 is a sequence diagram (2) illustrating operations performed by terminals A, B, and C.

FIG. 6 is a sequence diagram (3) illustrating operations performed by terminals A, B, and C.

FIG. 7 is a sequence diagram (4) illustrating operations performed by terminals A, B, and C.

FIG. 8 is a flowchart illustrating operations performed by a terminal A or a terminal B.

FIG. 9 is a flowchart illustrating operations performed by a terminal C.

### BEST MODE FOR CARRYING OUT THE INVENTION

Preferred embodiments of the present invention shall now be described in detail in accordance with the accompanying drawings.

### First Embodiment

Hereinafter, a communication apparatus according to the present invention shall be described in details with reference to the drawings. Although the following describes an example that uses a wireless LAN system compliant with the IEEE 802.11 series, the present invention can be applied to other communication schemes as well.

First, a hardware configuration used in a preferred embodiment of the invention shall be described.

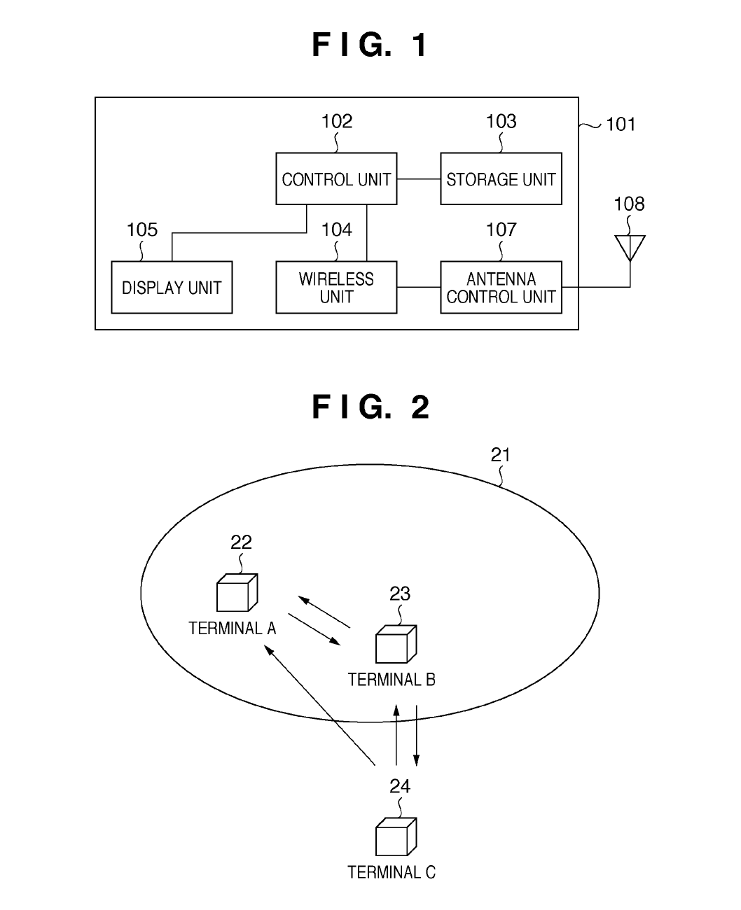

FIG. 1 is a block diagram illustrating an example of the configuration of a communication apparatus according to the present embodiment. 101 indicates the overall communication apparatus. 102 is a control unit that controls the overall apparatus by executing a control program stored in a storage unit 103. The control unit 102 also performs sequence control for exchanging encryption keys with other communication apparatuses. 103 is a storage unit that stores the control program executed by the control unit 102 as well as various information such as communication parameters. The various operations illustrated in the operation flowcharts and sequence charts mentioned later are carried out by the control unit 102 executing the control program stored in the storage unit 103. 104 is a wireless unit for performing wireless communication. 105 is a display unit that displays various items, and has functionality rendering it capable of outputting visually-recognizable information using an LCD, LEDs, or the like, or performing audio output using a speaker or the like. 107 is an antenna control unit, and 108 is an antenna.

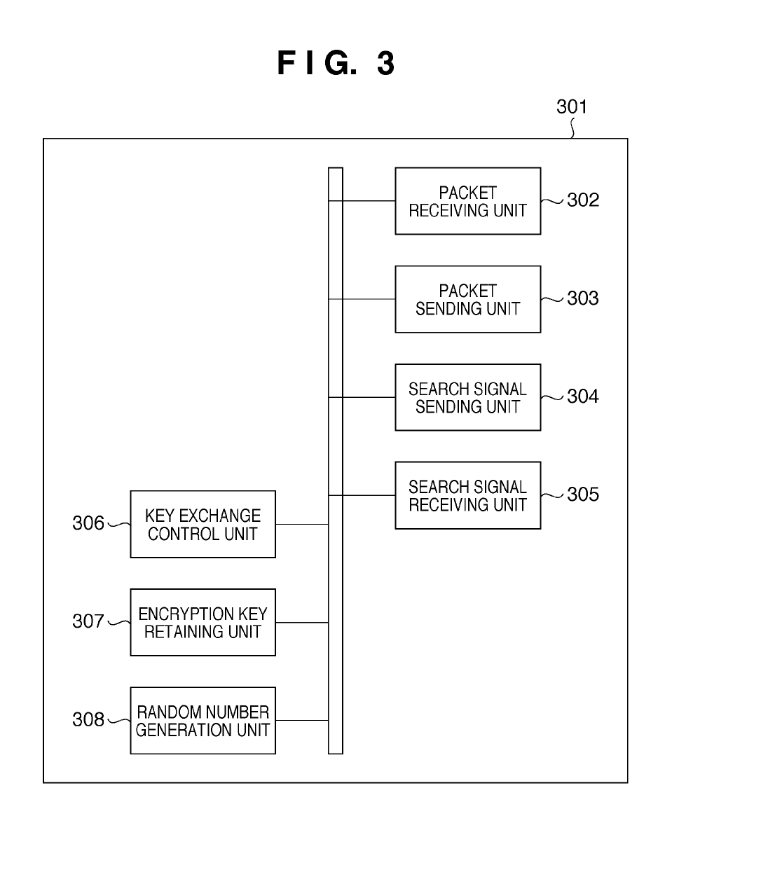

FIG. 3 is a block diagram illustrating an example of the configuration of software function blocks executed by the communication apparatus according to the present embodiment.

301 indicates the overall terminal. 302 is a packet receiving unit that receives packets for various types of communication. 303 is a packet sending unit that sends packets for various types of communication. 304 is a search signal sending unit that controls the sending of a device search signal, such as a probe request. The sending of probe requests, discussed later, is carried out by the search signal sending unit 304. Furthermore, the sending of probe responses, which are response signals for received probe requests, is also carried out by the search signal sending unit 304.

305 is a search signal receiving unit that controls the receiving of a device search signal, such as a probe request, from another terminal. The receiving of probe requests, discussed later, is carried out by the search signal receiving unit 305. The receiving of probe responses is also carried out by the search signal receiving unit 305. Note that various information of the device that sent the probe response (self information) is added to each probe response.

306 is a key exchange control unit that performs control of processing sequences for exchanging session keys and group keys with other communication apparatuses. The key exchange control unit 306 performs the various messaging processes used in four-way handshakes and group key handshakes carried out in the WPA key exchange processing exemplified in the present embodiment.

The four-way handshake and group key handshake of WPA (Wi-Fi Protected Access) shall be described briefly hereinafter. In the present embodiment, the four-way handshake and the group key handshake are described as processes for exchanging encryption keys. However, it is also possible to describe these as sharing processes for sharing encryption keys, where one communication apparatus provides an encryption key or information regarding an encryption key to a partner communication apparatus.

The four-way handshake and group key handshake are executed between an authenticating device (an authenticator) and the authenticated device (a supplicant). Note that the following discusses the authenticating device (authenticator) as being the device that performs authentication and the authenticated device (supplicant) as being the device that is authenticated.

In a four-way handshake, the authenticator and supplicant share a shared key in advance (a pre-shared key), and this pre-shared key is used when generating a session key.

First, the authenticator generates a random number (a first random number), and sends a message 1 that includes the generated first random number to the supplicant.

Having received the message 1, the supplicant also generates a random number (a second random number) itself. The supplicant then generates a session key from the second random number it generated itself, the first random number received from the authenticator, and the pre-shared key.

Having generated the session key, the supplicant sends a message 2 that includes the second random number and its own encryption/authentication support information (WPAIE or RSNIE) to the authenticator.

Having received the message 2, the authenticator generates a session key from the first random number it generated itself, the second random number received from the supplicant, and the pre-sharing key. At this stage, the authenticator and the supplicant generate the same session key if their first random numbers, second random numbers, and pre-shared keys are identical.

Having generated the session key, the authenticator sends a message 3 that includes its own encryption/authentication support information (WPAIE or RSNIE) and a session key install instruction to the supplicant.

The authenticator and the supplicant can install the session key upon the sending/receiving of the message 3.

Having received the message 3, the supplicant sends a message 4 to the authenticator, notifying the authenticator that the message 3 has been received.

In this manner, the session key, serving as the encryption key, is exchanged through a four-way handshake, in which the messages 1 through 4 are sent/received between the authenticator and the supplicant (in actuality, random numbers for generating the session key are exchanged). Through this exchange, the encryption key can be shared on the network.

Note that session key can be installed upon the sending/receiving of the message 4.

Meanwhile, in the group key handshake, the authenticator encrypts a group key using the session key exchanged in the four-way handshake. The authenticator then sends a message 1 that includes the encrypted group key to the supplicant. The group key is an encryption key for performing group communication. The group key is therefore sent in the case where the group key that is already being shared with another communication apparatus is to be shared with the supplicant as well. The authenticator generates the group key and sends the generated group key to the supplicant in the case where there is no group key that is being shared with another communication apparatus or the group key that is shared with another communication apparatus is not to be shared with the supplicant.

The supplicant decrypts the group key that is included in the received message 1 using the session key, and sends a message 2 to the authenticator, notifying the authenticator that the message 1 has been received.

In this manner, the group key, serving as the encryption key for group communication, can be shared through a group key handshake, in which the messages 1 and 2 are sent/received between the authenticator and the supplicant.

As described thus far, the authenticator can be referred to as a providing apparatus that provides an encryption key, whereas the supplicant can be referred to as a receiving apparatus (receiving device, etc.) that receives the encryption key provided by the authenticator (the providing apparatus).

Note that the four-way handshake and the group key handshake have been standardized by IEEE 802.11i, and thus the IEEE 802.11i specification should be referred to for details thereof.

307 is an encryption key retaining unit that retains the session keys and group keys exchanged by the key exchange control unit 306. Whether or not a key exchange has taken place with another communication apparatus can be determined based on the information retained in the encryption key retaining unit 307.

308 is a random number generation unit. It is the random number generation unit 308 that generates the random number information used when the key exchange control unit 306 generates the session key as described earlier. A random number generated by the random number generation unit 308 may also be used when generating the group key.

Note that all the functional blocks have mutual relationships whether implemented as software or hardware. Furthermore, the abovementioned functional blocks are examples; a single functional block may be made up of multiple functional blocks, and any of the functional blocks may be further divided into blocks that perform multiple functions.

FIG. 2 is a diagram illustrating terminals A22, B23, and C24, as well as an ad-hoc network 21 created by the terminals A22 and B23.

Each terminal is provided with functionality for wireless LAN communication based on IEEE 802.11, performs wireless communication through wireless LAN ad-hoc (hereinafter, simply “ad-hoc”) communication, and has the configuration described earlier with reference to FIGS. 1 and 3.

FIG. 2 assumes that the terminal A22 (hereinafter called “terminal A”) and the terminal B23 (hereinafter called “terminal B”) have already exchanged encryption keys. In the present embodiment, the terminal A acts as the authenticator and the terminal B acts as the supplicant in the encryption key exchange process that has taken place between the terminals A and B. Furthermore, in order to unify the encryption key shared between the terminals, the process for exchanging encryption keys is assumed to be carried out with the terminal whose MAC (Media Access Control) address is highest acting as the authenticator. Note that the size relationship of the MAC addresses is determined through a comparison based on lexicographic order.

Here, consider a situation in which a new communication apparatus, the terminal C24 (hereinafter called “terminal C”) joins the network 21, which has been established through the exchange of encryption keys.

In order for the terminal C to join the network 21, the terminal C first sends a probe request through broadcasting (the terminal to be searched for is not specified), whereupon one of the terminals that makes up the network 21, or the terminal A or terminal B, returns a probe response. Here, in an IEEE 802.11 wireless LAN ad-hoc network, each terminal sends beacons at random. When a probe request has been sent through broadcasting, it is specified that the terminal that sent a beacon immediately prior to receiving the probe request is to return the probe response. Meanwhile, in the case where a probe request is sent through unicast (the terminal to be searched for is specified), it is stipulated that the terminal that has been specified is to send the probe response.

The processing sequence changes depending on whether the terminal A or the terminal B returned the probe response. In addition, the processing sequence performed when the terminal C joins the network 21 also differs depending on the role of the terminal that returned the probe response with respect to the encryption key exchange process that was active when the probe request was received from the terminal C.

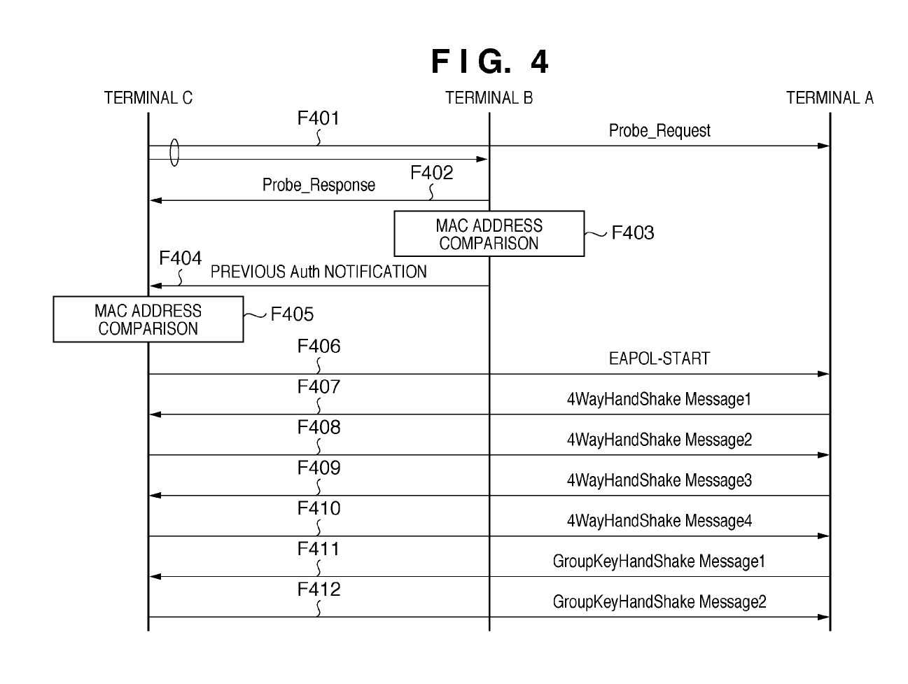

FIG. 4 is a diagram illustrating a processing sequence performed in the case where the terminal C has received a probe response from the terminal B upon sending a probe request, when the MAC address size relationship of the terminals is terminal A>terminal B>terminal C.

Here, the sequence chart of FIG. 4 shall be described.

First, the terminal C sends a probe request through broadcasting in order to attempt to join the network 21, which has been created by the terminals A and B (F401).

Of the terminals A and B, the terminal that has received the probe request returns a probe response to the terminal C. Here, the terminal B has sent a beacon immediately prior to receiving the probe request, and thus the probe response is returned by the terminal B to the terminal C (F402).

The terminal B, which returned the probe response, compares the size of its own MAC address to that of the MAC address of the destination of the probe response (in other words, the MAC address of the terminal C, which is the source of the probe request) and determines the size relationship therebetween (F403).

As a result of this comparison, the terminal B determines that the MAC addresses of the terminals C and B are in a size relationship in which terminal B>terminal C. The terminal B then notifies the terminal C of information (the MAC address or the like) of the previous authenticator (F404).

Here, “previous authenticator” refers to the terminal that functioned as the authenticator in the encryption key exchange process carried out among the terminals already present on the network that the new terminal is attempting to join. In the present sequence, the terminal A, which functioned as the authenticator in the encryption key exchange process carried out between the terminals A and B, is the previous authenticator.

The terminal C then compares its own MAC address with the MAC address of the previous authenticator received in F404 (that is, the MAC address of the terminal A) (F405). Here, the terminal C determines that the MAC addresses of the terminals C and A are in a size relationship in which terminal A>terminal C, and thus it is determined that the terminal A is to be the authenticator and the terminal C is to be the supplicant. The terminal C then sends an EAPOL-START to the terminal A in order to request the initiation of the four-way handshake (F406). The “EAPOL-START” referred to here is a message used to request the initiation of authentication, and is, in the present embodiment, used as a message for requesting the initiation of the encryption key exchange process.

Having received the EAPOL-START, the terminal A sends the message 1 of the four-way handshake to the terminal C (F407). If the terminals A and C are capable of communication, the four-way handshake is continued, after which the group key handshake is carried out (F408 to F412).

The mechanisms of the four-way handshake and the group key handshake are as described in the IEEE 802.11i specification, as mentioned earlier, and thus the details thereof shall be omitted here.

Note that in the case where the information of the previous authenticator terminal A has been received in F404, the terminal C may send a probe request through unicast, specifying the previous authenticator terminal A, without immediately carrying out the MAC address comparison (F405). In this case, when a probe response has been received from the previous authenticator terminal A, the encryption key exchange process can be carried out after confirming whether or not the previous authenticator is present on the network by performing the processing from F405 on. When the probe response cannot be received from the previous authenticator terminal A for a set amount of time, it can be thought that electromagnetic interference or the like has rendered communication impossible, or that the previous authenticator has left the network. Therefore, in such a case, the probe request is once again sent to the terminal A after a set amount of time has passed, and the encryption key exchange process is carried out once the presence of the terminal A has been confirmed. If, however, there is no response even after the probe request has been sent a predetermined number of times, the encryption key exchange process with the terminal A is suspended, and the encryption key exchange process is instead carried out between the terminal C and the terminal B by the terminal C sending the EAPOL-START to the terminal B.

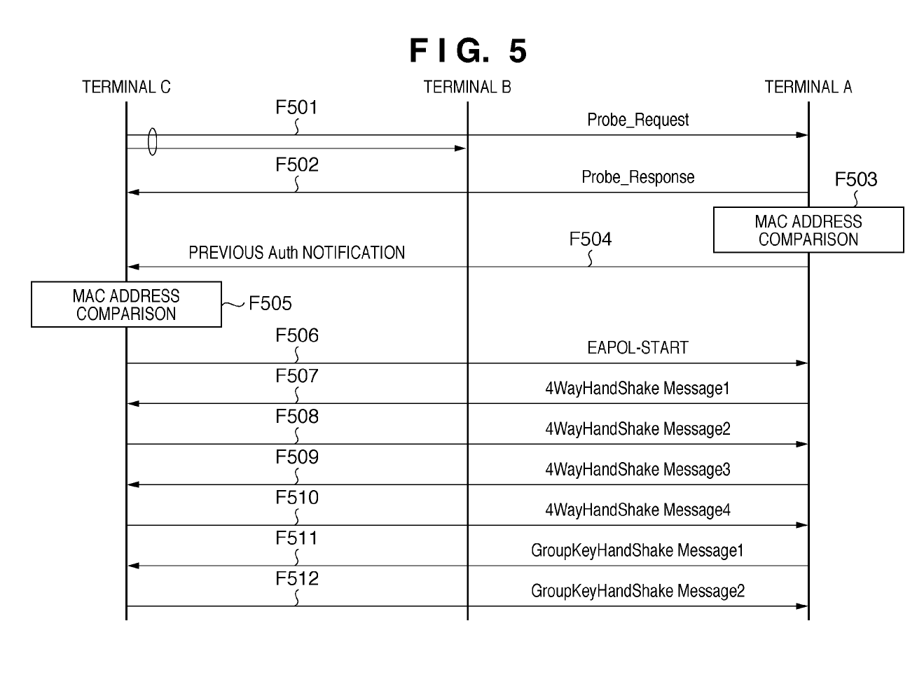

FIG. 4 illustrates a case where the terminal B returns a probe response in response to a probe request sent by the terminal C. Next, a sequence performed when the terminal A returns a probe response shall be described with reference to FIG. 5.

First, the terminal C sends a probe request through broadcasting in order to attempt to join the network 21, which has been created by the terminals A and B (F501).

Of the terminals A and B, the terminal that has received the probe request returns a probe response to the terminal C. Here, the terminal A has sent a beacon immediately prior to receiving the probe request, and thus the probe response is returned by the terminal A to the terminal C (F502).

The terminal A, which returned the probe response, compares the size of its own MAC address to that of the MAC address of the destination of the probe response (in other words, the MAC address of the terminal C, which is the source of the probe request) and determines the size relationship therebetween (F503).

As a result of this comparison, the terminal A determines that the MAC addresses of the terminals C and A are in a size relationship in which terminal C<terminal A. The terminal A then notifies the terminal C of information (the MAC address or the like) of the previous authenticator (the terminal A, which functioned as the authenticator in the key exchange process carried out with the terminal B) (F504).

The terminal C then compares its own MAC address with the MAC address of the authenticator received in F504 (that is, the MAC address of the terminal A) (F505). Here, the terminal C determines that the MAC addresses of the terminals C and A are in a size relationship in which terminal A>terminal C, and thus it is determined that the terminal A is to be the authenticator and the terminal C is to be the supplicant. The terminal C then sends an EAPOL-START to the terminal A in order to request the initiation of the four-way handshake (F506).

Having received the EAPOL-START, the terminal A sends the message 1 of the four-way handshake to the terminal C (F507). If the terminals A and C are capable of communication, the four-way handshake is continued, after which the group key handshake is carried out (F508 to F512).

Although FIGS. 4 and 5 illustrate the case where the relationship between the MAC addresses of the terminals is terminal A>terminal B>terminal C, a case can also be considered where the relationship is terminal A>terminal C>terminal B or terminal C>terminal A>terminal B.

Next, the case where the size relationship between the MAC addresses of the terminals is terminal A>terminal C>terminal B shall be considered.

As in the aforementioned case where the relationship is terminal A>terminal B>terminal C, two situations, where the source of the probe response is either the terminal A or the terminal B, can be considered.

First, in the case where the terminal A has returned the probe response, the terminal C understands that the size relationship of the MAC addresses is terminal A>terminal C, resulting in the same sequence as that shown in FIG. 5.

Similarly, in the case where the terminal B has returned the probe response, the terminal B determines, in F403 of FIG. 4, that the size relationship of the MAC addresses is terminal C>terminal B, and therefore sends the information of the previous authenticator, or the terminal A, to the terminal C. This results in the same sequence as that illustrated earlier in FIG. 4.

Finally, the case where the size relationship between the MAC addresses of the terminals is terminal C>terminal A>terminal B shall be considered.

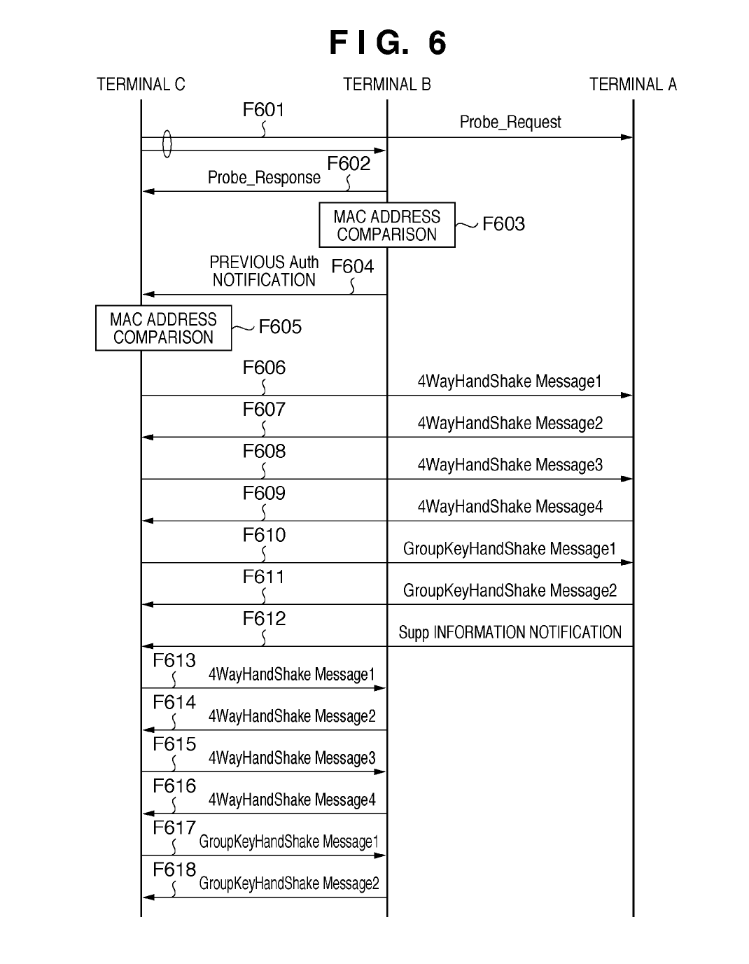

In this case, too, two situations, where the source of the probe response is either the terminal A or the terminal B, can be considered. First, the case where the terminal B returns a probe response shall be described with reference to FIG. 6.

First, the terminal C sends a probe request through broadcasting in order to attempt to join the network 21, which has been created by the terminals A and B (F601).

Of the terminals A and B, the terminal that has received the probe request returns a probe response to the terminal C. Here, the terminal B has sent a beacon immediately prior to receiving the probe request, and thus the probe response is returned by the terminal B to the terminal C (F602).

The terminal B, which returned the probe response, compares the size of its own MAC address to that of the MAC address of the destination of the probe response (in other words, the MAC address of the terminal C, which is the source of the probe request) and determines the size relationship therebetween (F603).

As a result of this comparison, the terminal B determines that the MAC addresses of the terminals C and B are in a size relationship in which terminal C>terminal B. The terminal B then notifies the terminal C of information (the MAC address or the like) of the previous authenticator (the terminal A, which functioned as the authenticator in the key exchange process carried out with the terminal B) (F604).

The terminal C then compares its own MAC address with the MAC address of the terminal A included in the notification sent by the terminal B (F605), and determines that terminal C>terminal A. Through this, the terminal C determines that it is to be the authenticator itself, and sends the message 1 of the four-way handshake to the terminal A (F606). If the terminals A and C are capable of communication, the four-way handshake is continued, after which the group key handshake is carried out (F607 to F611).

In order for the role of network authenticator, which has thus far been played by the terminal A, to be passed on to the terminal C, the terminal A communicates information of the supplicant it is aware of (in the present embodiment, information of the terminal B) to the terminal C (F612).

Having been notified of the information of the supplicant, the terminal C performs a new encryption key exchange process with each supplicant (F613 to F618).

Note that in F612, the terminal A may notify the supplicant it is aware of that the terminal C is the new authenticator, rather than communicating the information of that supplicant to the terminal C. In this case, the supplicant, which has received the notification, can perform the encryption key exchange process with the terminal C by sending the EAPOL-START to the terminal C.

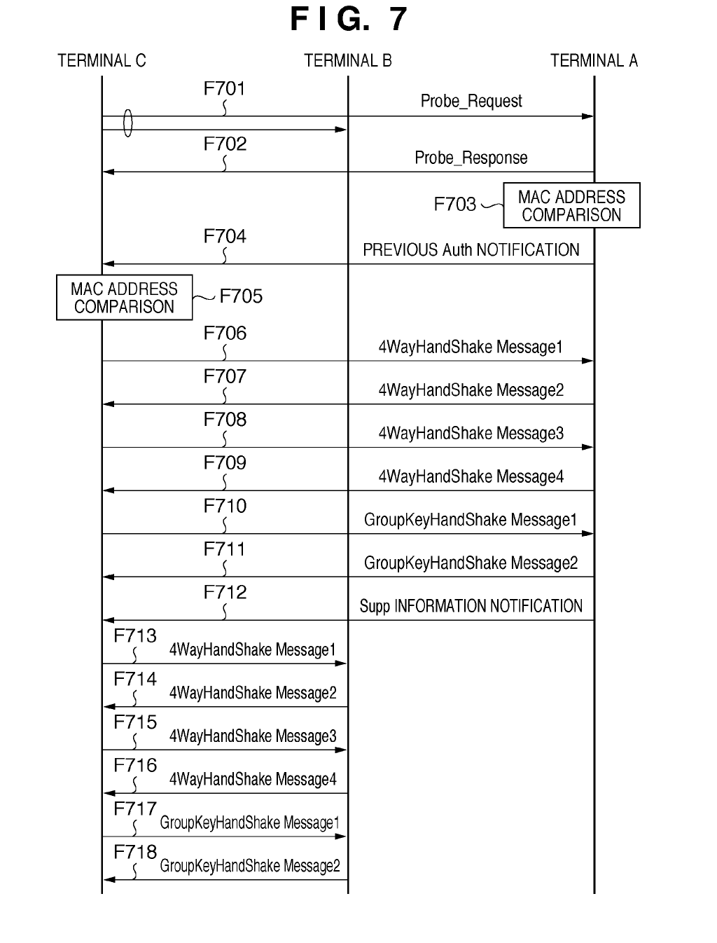

Next, a sequence performed when the terminal A returns a probe response shall be described with reference to FIG. 7.

First, the terminal C sends a probe request through broadcasting in order to attempt to join the network 21, which has been created by the terminals A and B (F701).

Of the terminals A and B, the terminal that has received the probe request returns a probe response to the terminal C. Here, the terminal A has sent a beacon immediately prior to receiving the probe request, and thus the probe response is returned by the terminal A to the terminal C (F702).

The terminal A, which returned the probe response, compares the size of its own MAC address to that of the MAC address of the destination of the probe response (in other words, the MAC address of the terminal C, which is the source of the probe request) and determines the size relationship therebetween (F703).

As a result of this comparison, the terminal A determines that the MAC addresses of the terminals C and A are in a size relationship in which terminal C>terminal A. The terminal A then notifies the terminal C of information (the MAC address or the like) of the previous authenticator (the terminal A, which functioned as the authenticator in the key exchange process carried out with the terminal B) (F704).

The terminal C then compares its own MAC address with the MAC address of the terminal A included in the notification sent by the terminal A (F705), and determines that terminal C>terminal A. Through this, the terminal C determines that it is to be the authenticator itself, and sends the message 1 of the four-way handshake to the terminal A (F706).

If the terminals A and C are capable of communication, the four-way handshake is continued, after which the group key handshake is carried out (F707 to F711).

In order for the role of network authenticator, which has thus far been played by the terminal A, to be passed on to the terminal C, the terminal A communicates information of the supplicant it is aware of (in the present embodiment, information of the terminal B) to the terminal C (F712). Having been notified of the information of the supplicant, the terminal C performs a new encryption key exchange process with each supplicant (F713 to F718).

Note that in F712, the terminal A may notify the supplicant it is aware of that the terminal C is the new authenticator, rather than communicating the information of that supplicant to the terminal C. In this case, the supplicant, which has received the notification, can initiate the encryption key exchange process with the terminal C by sending the EAPOL-START to the terminal C.

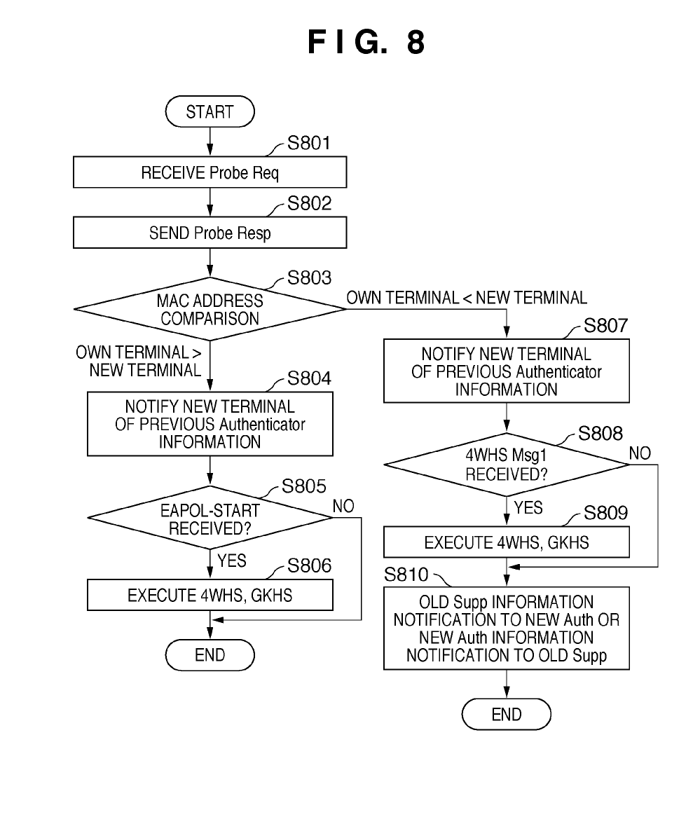

Operational flowcharts for each terminal, used to implement the processing sequences described thus far, shall now be described. FIG. 8 is a diagram illustrating the operational flow of a terminal, among terminals present on the preexisting network 21 (called “preexisting terminals” hereinafter), that responds to a probe request from a new terminal.

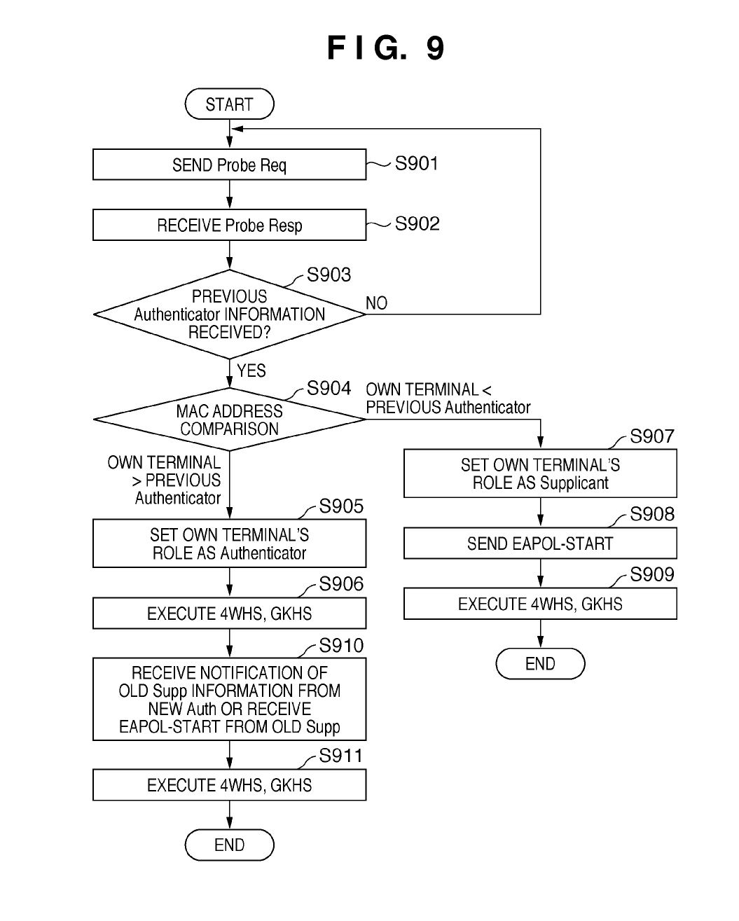

Similarly, FIG. 9 illustrates an operational flowchart for a new terminal C.

FIG. 8 shall be described first.

First, the preexisting terminal (in the present embodiment, terminal A or terminal B) receives a probe request sent through broadcasting by the new terminal (in the present embodiment, the terminal C) (S801). Among the preexisting terminals that received the probe request, the preexisting terminal that sent a beacon immediately prior to receiving the probe request sends a probe response (S802). The following descriptions assume that the preexisting terminal A has sent the probe response.

The preexisting terminal A that sent the probe response then compares its own MAC address with that of the destination terminal of the probe response (the new terminal C) (S803).

In the case where the comparison of S803 indicates that the MAC address of the preexisting terminal A is greater than the MAC address of the new terminal C, the preexisting terminal A sends information (a MAC address of the like) of the previous authenticator terminal to the new terminal C (S804). As described earlier with reference to the various sequences, “previous authenticator” refers to the terminal that functioned as the authenticator in the encryption key exchange process carried out between the preexisting terminals A and B on the network that the new terminal C is attempting to join.

Therefore, there are cases where the previous authenticator terminal is also the preexisting terminal A itself.

After this, the preexisting terminal A waits for the EAPOL-START to be sent from the new terminal C (S805). In the case where the EAPOL-START has been received, the preexisting terminal A executes the four-way handshake and the group key handshake with the new terminal C, and completes the encryption key exchange process (S806).

However, in the case where the comparison of S803 indicates that the MAC address of the preexisting terminal A is lower than the MAC address of the new terminal C, the preexisting terminal A sends information (a MAC address of the like) of the previous authenticator terminal to the new terminal C (S807).

After this, the preexisting terminal A then waits for the reception of the message 1 of the four-way handshake from the new terminal C (S808). In the case where the message 1 of the four-way handshake has been received, the preexisting terminal A executes the rest of the four-way handshake and the group key handshake with the new terminal C, and completes the encryption key exchange process (S809).

Next, in the case where the preexisting terminal A is the previous authenticator terminal, the preexisting terminal A transfers information of the supplicants it has been aware of thus far (in this case, the terminal B) to the new terminal C in order to unify the encryption keys across the network (S810). In this case, the new authenticator terminal C carries out the encryption key exchange process with the terminal B based on the information forwarded from the preexisting terminal A.

Note that in S810, the preexisting terminal A may notify the supplicants it is aware of (in this case, the terminal A) of the information of the new authenticator terminal C. In this case, the terminal B sends the EAPOL-START to the terminal C, thereby carrying out the encryption key exchange process.

It should also be noted that in the case where the preexisting terminal A is not the previous authenticator terminal (in other words, is a supplicant terminal), the processing in S810 is omitted.

Next, operations performed by a new terminal shall be described with reference to FIG. 9.

First, the new terminal (in the present embodiment, terminal C) sends a probe request through broadcasting (S901). The new terminal C then receives a probe response from the preexisting terminal that received the probe request (S902). As with the descriptions of FIG. 8, the following descriptions assume that the terminal A has sent the probe response.

The new terminal C then waits to receive information (a MAC address or the like) of the previous authenticator from the source of the probe response, or the terminal A (S903). In the case where the information is not received, the network is not compliant with the present embodiment; therefore, the process is repeated from the step of searching for a network, and a compliant network is searched for.

However, in the case where the information of the previous authenticator has been received, the terminal C compares its own MAC address with the MAC address of the previous authenticator terminal (S904).

Note that there are also cases where the MAC address of the previous authenticator terminal is the same as the MAC address of the source of the probe response, or the terminal A.

It should be noted that, as illustrated by the sequence in FIG. 4, the probe request may be sent to the previous authenticator through unicast when the information of the previous authenticator has been received. This makes it possible to execute the encryption key exchange process after confirming whether or not the previous authenticator is present on the network.

In the case where the result of the comparison indicates that the MAC address of the new terminal C itself is greater than the MAC address of the previous authenticator terminal, the new terminal C determines its own role to be that of the authenticator (S905).

Because the new terminal C has determined that its own role is that of the authenticator, the new terminal C executes the four-way handshake and the group key handshake with the source of the probe response, or the terminal A (S906).

Then, upon receiving the information of the supplicant terminal from the previous authenticator terminal (S910), the new terminal C executes the four-way handshake and the group key handshake with the supplicant terminal, and completes the encryption key exchange process (S911). Note that in the case where, in S910, the EAPOL-START has been received form the supplicant terminal instead of the notification of the information of the supplicant terminal, the four-way handshake and the group key handshake is executed with that supplicant terminal (S911).

In the case where the result of the MAC address comparison in S904 indicates that the MAC address of the new terminal C itself is lower than the MAC address of the previous authenticator terminal, the new terminal C determines its own role to be that of the supplicant (S907).

In the case where the new terminal C has determined that its own role is that of the supplicant, the new terminal C sends the EAPOL-START to the previous authenticator terminal (S908).

The four-way handshake and the group key handshake are then executed, and the encryption key exchange process is completed (S909).

The descriptions thus far have discussed the operational flow of a terminal that attempts to newly join an existing network.

As described thus far, keys can easily be unified across an entire network by a new terminal determining whether it itself is to be the authenticator or the supplicant based on information of the previous authenticator acquired from the preexisting terminal by the new terminal.

Although an embodiment of the present invention has been described thus far, it should be noted that this merely describes an example of the present invention, and the scope of the present invention is not intended to be limited to the foregoing embodiment. The embodiment may be modified in various ways without departing from the essential spirit of the present invention.

For example, while the above embodiment describes using a key exchange message specified by the WPA standard, the key exchange method is not limited thereto. Any key exchange method may be used as long as it enables the fulfillment of the same roles.

Furthermore, although the sizes of MAC addresses are used to determine the roles in the key exchange process, this determination may be performed using identification information aside from the MAC addresses.

Furthermore, the above embodiment describes a case where the new terminal C joins a network which two terminals A and B are already joining. The abovementioned previous authenticator has been described, in this case, as referring to the terminal A, which functioned as the authenticator in the encryption key exchange process carried out between the terminal A and the terminal B. Here, a case where the encryption key exchange process is carried out in order for a new terminal D to join the network, after the terminal C has joined the network, shall be described. In this case, the information of the terminal that functioned as the authenticator in the encryption key exchange process when the terminal C joined, in S804 or S807 in FIG. 8, is communicated to the new terminal D as previous authenticator information.

The above descriptions discussed a wireless LAN compliant with the IEEE 802.11 standard as an example. However, the present invention may be applied in another wireless medium, such as wireless USB, MBOA, Bluetooth®, UWB, ZigBee, or the like. The present invention may also be applied in a wired communication medium such as a wired LAN.

“MBOA” is an acronym of “Multi Band OFDM Alliance”. Furthermore, UWB includes systems such as wireless USB, wireless 1394, WINET, and so on.

The present invention can also be achieved by supplying, to a system or apparatus, a storage medium in which the program code for software that realizes the aforementioned functions has been stored, and causing a computer (CPU or MPU) of the system or apparatus to read out and execute the program code stored in the storage medium. In this case, program code itself that is loaded from the storage medium realizes the functions of the above-described embodiment, and the storage medium that stores the program code falls within the scope of the present invention.

Examples of the storage medium that can be used to supply the program code include flexible disks, hard disks, optical disks, magneto-optical disks, CD-ROMs, CD-Rs, magnetic tape, non-volatile memory cards, ROMs, DVDs, and so on.

Furthermore, not only can the functionality of the aforementioned embodiment be implemented by the computer executing the read-out program code, but an OS or the like running on that computer can also execute part or all of the actual processing based on instructions from that program code, thereby implanting the aforementioned functionality. Note that “OS” is an acronym of “operating system”.

Furthermore, the program code read out from the storage medium may be written into a memory provided in a function expansion board installed in the computer or a function expansion unit connected to the computer. In this case, the aforementioned functionality may be implemented by a CPU included in the function expansion board or the function expansion unit performing part or all of the actual processing based on the instructions of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-314794, filed on Dec. 5, 2007, which is hereby incorporated by reference herein in its entirety.

1. A first communication apparatus that functions as one of (i) a providing apparatus that provides an encryption key and (ii) a receiving apparatus that receives an encryption key provided by a providing apparatus, and that performs a key sharing process for sharing an encryption key with another apparatus, the first communication apparatus comprising:
an acquisition unit adapted to acquire identification information of a second communication apparatus that functioned as the providing apparatus in a key sharing process performed among a plurality of apparatuses on a network which the first communication apparatus is joining; and
a determination unit adapted to determine whether the first communication apparatus is to function as the providing apparatus or as the receiving apparatus, based on the result of a comparison between the identification information of the second communication apparatus acquired by the acquisition unit and identification information of the first communication apparatus.

2. The first communication apparatus according to claim 1, further comprising a search unit adapted to send a search signal for searching for a network to join,
wherein the acquisition unit acquires the identification information of the second communication apparatus from a device that sends a response to the search signal.

3. The first communication apparatus according to claim 1, wherein the first communication apparatus initiates the key sharing process with the second communication apparatus in the case where the determination means has determined that the first communication apparatus is to function as the providing apparatus.

4. The first communication apparatus according to claim 3, further comprising a receiving unit adapted to receive, from the second communication apparatus, identification information of a third communication apparatus that functioned as the receiving apparatus in the key sharing process performed among the plurality of apparatuses present on the network which the first communication apparatus is joining,
wherein the first communication apparatus initiates the encryption key sharing process with the third communication apparatus.

5. The first communication apparatus according to claim 1, wherein the second communication apparatus is requested to initiate the key sharing process in the case where the determination unit has determined that the first communication apparatus is to function as the receiving apparatus.

6. The first communication apparatus according to claim 1, wherein the first communication apparatus is an apparatus that is joining an existing network, and the acquisition performed by the acquisition means and the determination performed by the determination means are performed upon joining the network.

7. A control method for a first communication apparatus that functions as one of (i) a providing apparatus that provides an encryption key and (ii) a receiving apparatus that receives an encryption key provided by a providing apparatus, and that performs a key sharing process for sharing an encryption key with another apparatus, the method comprising the steps of:
acquiring identification information of a second communication apparatus that functioned as the providing apparatus in a key sharing process performed among a plurality of apparatuses on a network which the first communication apparatus is joining; and
determining whether the first communication apparatus is to function as the providing apparatus or as the receiving apparatus based on the result of a comparison between the identification information of the second communication apparatus acquired in the step of acquiring and identification information of the first communication apparatus.

8. A computer-readable storage medium in which is stored a program for causing a computer to control a first communication apparatus to perform the method of to claim 7.
